(19) United States
(12) Patent Application Publication
(10) Pub. No.: US 2016/0205081 A1
(43) Pub. Date: Jul. 14, 2016

(54) HIERARCHICAL DATA SECURITY

(71) Applicant: Microsoft Technology Licensing, LLC, Redmond, WA (US)

(72) Inventors: Brandon J. Simons, Kirkland, WA (US); Mahesh Hariharan, Hyderabad (IN); Elliot S. Lewis, Bellevue, WA (US); Devendra Kumar, Bellevue, WA (US); Atul Shenoy, Seattle, WA (US)

(21) Appl. No.: 14/596,930

(22) Filed: Jan. 14, 2015

(51) Int. Cl. H04L 29/06; G06F 3/0484; H04L 12/24

(52) U.S. Cl. CPC H04L 63/08; H04L 41/22; G06F 3/0484

(57) ABSTRACT

A computing system comprises, in one example, a user interface component configured to generate a data security configuration interface that displays user input mechanisms and receives user configuration inputs, and a data security component configured to control user data access. The data security component comprises a plurality of configurable security objects arranged in a security hierarchy. The configuration inputs associate at least one user with each security object in the security hierarchy to define a data access relationship between the users associated with the security objects. The data security component comprises a data access component configured to receive a data access request from a given user, identify a set of users that are associated with security objects in the security hierarchy relative to a security object to which the given user is associated, and provide the given user with access to data objects that are associated with the set of users.

### BACKGROUND

Many different types of computing systems employ a wide variety of different types of security. As one example, a computing system stores data as entities or other data records, and commonly includes process functionality that facilitates performing various processes or tasks on the data. Users log into or otherwise access the computing system in order to perform the processes and tasks. The data can include user data as well as entities or records that are used to describe various aspects of the computing system. A data security framework in the computing system operates to limit user access to various portions of the computing system.

The discussion above is merely provided for general background information and is not intended to be used as an aid in determining the scope of the claimed subject matter.

### SUMMARY

A computing system comprises, in one example, a user interface component configured to generate a data security configuration interface that displays user input mechanisms and receives user configuration inputs, and a data security component configured to control user data access. The data security component comprises a plurality of configurable security objects arranged in a security hierarchy. The configuration inputs associate at least one user with each security object in the security hierarchy to define a data access relationship between the users associated with the security objects. The data security component comprises a data access component configured to receive a data access request from a given user, identify a set of users that are associated with security objects in the security hierarchy relative to a security object to which the given user is associated, and provide the given user with access to data objects that are associated with the set of users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a data security architecture.

FIG. 2 illustrates a portion of a relational data store, in one example.

FIG. 3A illustrates one example of a security hierarchy model.

FIGS. 3B and 3C illustrate examples of a hierarchical security mapping table.

FIG. 4 is a flow diagram illustrating one example of a method for configuring a hierarchical security component.

FIG. 5 illustrates one example of a user interface display for configuring a hierarchical security component.

FIG. 6 illustrates one example of a user interface display for configuring a hierarchical security component.

FIG. 7 illustrates one example of a user interface display for configuring a hierarchical security component.

FIG. 8 is a flow diagram illustrating one example of a method for providing user data access using a hierarchical security component

FIG. 9 is a block diagram showing one example of the architecture illustrated in FIG. 1, deployed in a cloud computing architecture.

FIG. 10-14 show various examples of mobile devices that can be used with the architecture shown in FIG. 1.

FIG. 15 is a block diagram of one example computing environment.

### DETAILED DESCRIPTION

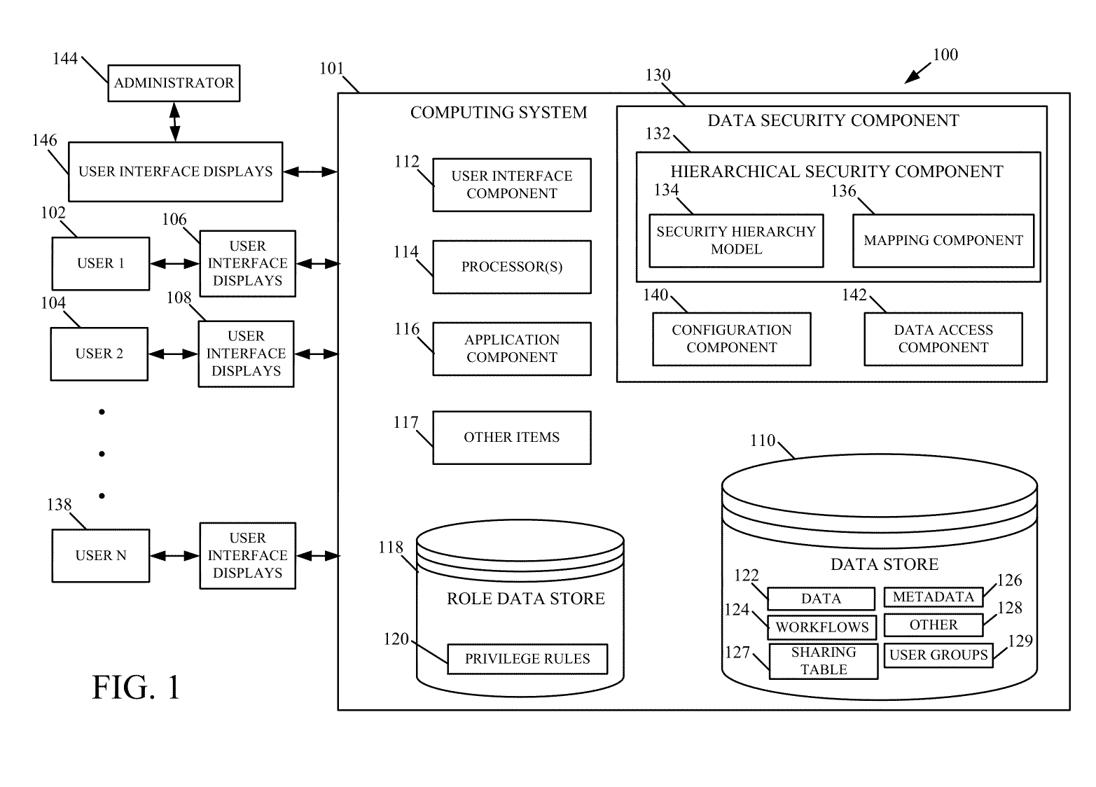

FIG. 1 is a block diagram of one example of a data security architecture 100. Architecture 100 includes a computing system 101 that is accessible by one or more users through one or more user interface displays. As shown in FIG. 1, a user 102 accesses system 101 through user interface displays 106 and a user 104 accesses system 101 through user interface displays 108. Each of users 102 and 104 can access computing system 101 locally or remotely. In one example, one or more of users 102 and 104 use a respective client device that communicates with computing system 101 over a wide area network, such as the Internet.

Users 102 and 104 interact with user input mechanisms to control and manipulate computing system 101. For instance, users 102 and 104 can access data in a data store 110. User data access can include, but is not limited to, read access, write access, and/or update access to the data. Updating data can include modifying and/or deleting data in data store 110. For sake of illustration, users 102 and 104 are shown accessing system 101 in FIG. 1. However, it is understood than any number N of users can access system 101.

In the example shown in FIG. 1, computing system 101 includes a user interface component 112, at least one processor 114, and an application component 116. System 101 can include other items 117 as well. In one example, but not by limitation, computing system 101 also includes a role data store 118 having role-based privilege rules 120 for users that access computing system 101, where a “role” is conceptually some class of person within an organization (e.g., engineer, system administrator, sales manager, sales person, marketing professional, etc.). The role-based privilege rules 120 are assigned to users who are employed in the various roles.

Processor 114 is illustratively a computer processor with associated memory and timing circuitry (not shown). Processor 114 is illustratively a functional part of system 101 and is activated by, and facilitates the functionality of, other systems and components and items in system 101.

Computing system 101 can be any type of system accessed by users 102 and 104. In one example, but not by limitation, computing system 101 can comprise an electronic mail (email) system, a collaboration system, a document sharing system, a scheduling system, and/or an enterprise system. In one example, computing system 101 comprises a business system, such as an enterprise resource planning (ERP) system, a customer resource management (CRM) system, a line-of-business system, or another business system.

As such, application component 116 can be any of a variety of different application types that facilitate functionality within computing system 101. By way of example, application component 116 accesses data 122 and/or workflows 124 that are implemented by application component 116 for users 102 and 104 of computing system 101 to perform processes and tasks. The information further includes metadata 126 and any other data 128 that can be used by application component 116 or other items in computing system 101. Application component 116 accesses the information in data store 110 in implementing the programs, workflows, or other operations performed by the application component 116.

User interface component 112 senses physical activities, for example by generating user interface displays that are used to sense user interaction with computing system 101. The user interface displays can include user input mechanisms that sense user inputs in a wide variety of different ways, such as point and click devices (e.g., a computer mouse or track ball), a keyboard (either virtual or hardware), a keypad, where the display device used to display the user interface displays is a touch sensitive display, the inputs can be provided as touch gestures. Similarly, the user inputs can illustratively be provided by voice inputs or other natural user interface input mechanisms as well.

As illustrated in FIG. 1, user interface component 112 is used by parts of system 101 to generate user interface displays 106 and 108 for users 102 and 104, respectively. In one example, one or more of user interface displays 106 and 108 include user input mechanisms that receive inputs from the user for manipulating application component 116 or for manipulating and interacting with other items in computing system 101.

FIG. 1 shows a variety of different functional blocks. It will be noted that the blocks can be consolidated so that more functionality is performed by each block, or they can be divided so that the functionality is further distributed.

It should also be noted that the above discussion has shown a number of data stores, including data store 110 and role data store 118. Data stores 110 and 118 can be any of a wide variety of different types of data stores. Further, while these are shown as two independent data stores, they could also be formed within a single data store. In addition, the data in those data stores can be stored in multiple additional data stores as well. Also, the data stores can be local to the environments, agents, modules, and/or components that access them, or they can be remote therefrom and accessible by those environments, agents, modules, and/or components. Similarly, some can be local while others are remote.

As mentioned above, computing system 101 receives access requests from users 102 and 104 to access data in data store 110. Computing system 101 includes a data security component 130 that controls user data access by defining and enforcing data access security privileges. Before describing the overall operation of data security component 130 in more detail, a brief overview will be provided.

By way of example, data store 110 comprises data objects, including various types of data entities or records, which are created, modified, and/or deleted by the users. In one particular example, data store 110 comprises a relational database, where each data object is stored in a row.

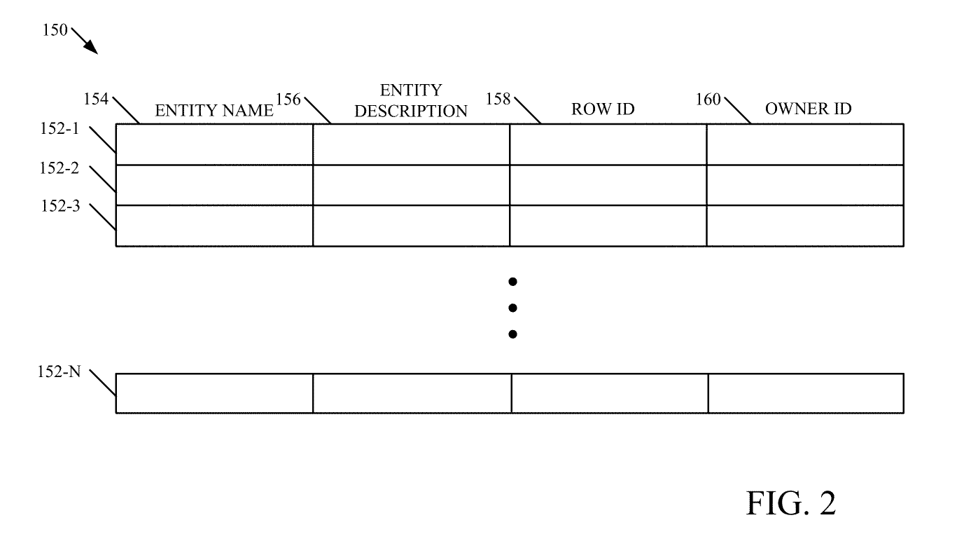

FIG. 2 illustrates a portion of a relational data store 150, in one example. Relational data store 150 has a plurality of rows 152-1, 152-2, 152-3, 152-N, etc. (collectively referred to as rows 152) each correspond to a stored data object. The data objects comprise a plurality of different entity types such as, but not limited to, accounts, emails, people, or any other data types used in computing system 101. Relational data store 150 includes a plurality of columns storing information for each data object. For example, a first column 154 that stores an entity name, a second column 156 stores an entity description, a third column 158 stores a unique identifier that uniquely identifies the row within the relational data store 150.

Data objects stored in data store 110 are associated with one or more users. A user association with a data object defines user access privileges for that data object. For example, a user can be associated with a data object by owning the data object or having the data object shared to them by another user. To illustrate, with respect to FIG. 1, if user 102 owns a particular data object, user 102 is provided with a first level of access privileges (e.g., user 102 can read, write, modify, delete, and/or share the data object). An owner of a data object is typically the user who created the data object. However, in one example, ownership of a data object can be assigned from one user to another. In the example data store of FIG. 2, a fourth column 160 stores an owner attribute in the form of an owner identifier (ID). A user identified by the owner ID is considered the owner of the corresponding data object.

If the data object is owned by user 104, but shared with user 102, user 102 is provided with a second, different level of access privileges (e.g., read-only access). Data object sharing can be performed by computing system 101 automatically, or through manual action by the user (e.g., user 104 using user interface displays 108 to select one or more other users to which the data object is to be shared). In one example, a sharing table 127 is maintained in data store 110 that maps stored data objects to users to which the data objects are shared.

Within computing system 101, a plurality of users can be associated together in a team or other organizational construct. A group or team of users can be defined by computing system 101 automatically, and/or manually through user input. In one example, user groups can be implied through an organizational structure and/or explicitly through user input. In FIG. 1, user group associations 129 can be stored in data store 110, for example as a mapping table that maps users to particular groups or teams.

Also, data objects can be owned by or shared with these user groups. In this manner, the owner ID column 160 in data store 150 can refer to a particular user group. Further, sharing table 127 can indicate that a user group has shared data with another user or user group. In one example, a user has access to data objects that are owned by that user, shared to that user, and/or owned or shared to a group or team of which the user is a member.

Data security component 130 also includes a hierarchical security component 132 configured to control user data access according to at least one security hierarchy model 134. In the illustrated example, hierarchical security component 132 includes a mapping component 136 that maps users based on security hierarchy model 134. Data security component 130 also includes a data access component 142 configured to provide access to data in data store 110 based on the mapping information in mapping component 136. In one particular example, mapping component 136 comprises a mapping table that defines, for a given user, other users for which the given user can access data.

As discussed in further detail below, but not by limitation, data security component 130 provides a flexible security architecture that is adaptable to the realities of an organizational structure, and easily modified as the organizational structure changes. Data security component 130 can enhance granularity in granting data access permissions. Further, hierarchical security component 132 can be implemented along with other types of data security architectures, such as, but not limited to, role hierarchies and business unit hierarchies. In one example, hierarchical security component 132 provides data access independent of role-based privilege rules 120, and does not rely upon a role hierarchy.

By way of example, security hierarchy model 134 comprises a plurality of configurable security objects that are arranged in a hierarchical structure. The security objects are configurable in that one or more users of computing system 101 can be selectively associated with each security object in a hierarchical arrangement that defines data access relationships among the users. The security objects and hierarchical arrangement can be defined in any of a number of ways.

First, it is noted that the process for defining security hierarchy model 134 can be manual, automatic, or semi-automatic. In the illustrated example, however, an administrator 144 uses a configuration component 140 to configure the security hierarchy model 134. Administrator 144 accesses computing system 101 through one or more user interface displays 146. Administrator 144 can be any user (such as a developer or analyst, or another person tasked with assigning data access privileges). The term administrator is used for the sake of example only.

Further, security hierarchy model 134 can be of a variety of different hierarchy types. For example, a user hierarchy model hierarchically maps users to one another in a data access relationship that defines how specific users can access data associated with other users. In one example, a user hierarchy model is defined by administrator 144 in an arbitrary manner. As such, a user hierarchy model can be independent of roles assigned to users and a role hierarchy defined within computing system 101. In one example, a user hierarchy can be defined intrinsically, for instance along organizational reporting lines, such as manager/employee relationships and the like. This type of a hierarchy is referred to herein as a “manager hierarchy.” These, of course, are examples only.

Security hierarchy model 134 can also map groups of users to other specific users or groups of users. For example, one hierarchy model can map a specific user to another specific user, a specific user to a group of users, and/or a group of users to another group of users.

In one example, a position hierarchy is used to hierarchically map groups of users. As mentioned above, user groups can be defined along any desired organization structure and/or arbitrarily. In one example, a position comprises an arbitrarily created group of users. In one example, a position comprises a department, a geographical region, a territory, a product line, etc.). These, of course, are examples only.

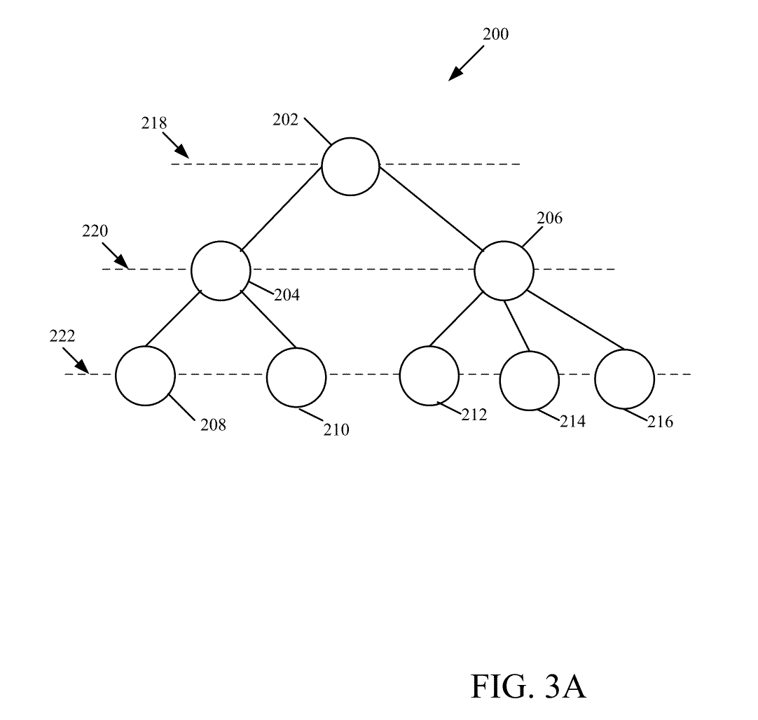

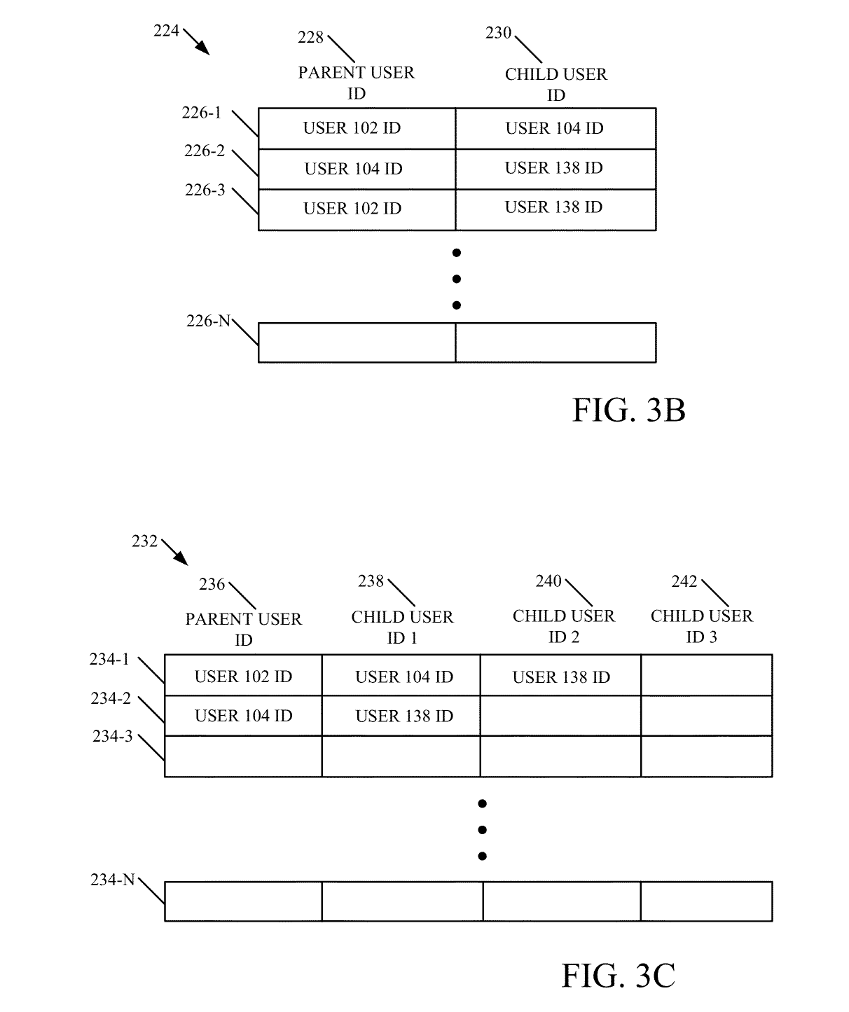

FIG. 3A illustrates one example of a hierarchy model 200. For sake of illustration, but not by limitation, hierarchy model 200 will be described in the context of architecture 100.

As shown in FIG. 3A, hierarchy model 200 comprises a plurality of security objects 202, 204, 206, 208, 210, 212, 214, and 216 arranged in a plurality of hierarchical levels 218, 220, and 222 based on configuration inputs from administrator 144. Each security object is represented as a node within a tree structure. The nodes are arranged in hierarchical parent/child relationships in which a parent node has one or more child nodes that depend therefrom, and each child node depends from at least one parent node. The number of levels and security objects shown in FIG. 3A is by way of example only. Any number of security objects and levels can be utilized.

The configuration inputs from administrator 144 associate at least one user with each of the security objects. An individual user, or a group of users (such as a team) can be associated with a security object. In one example, security object 202 can be associated with a single user and security object 204 can be associated with a group of users. However, for the sake of illustration, hierarchy model 200 will be describe as a user hierarchy in which each security object is associated with a single user.

Security hierarchy model 200 defines data access privileges for users of computing system 101 based on the relationships between the users defined by hierarchy model 200. In one example, a user is provided with access to data owned by or shared to other users (or groups of users) that are in a lower level of hierarchy model 200. Alternatively, or in addition, a user is provided with access to data owned by or shared to a group of users if one of the users in the group is at a lower level of hierarchy model 200. In one example, users can be provided access to data owned by or shared to other users (or groups of users) that are on a same level in the hierarchy.

By way of example, assume that user 102 is associated with security object 202, user 1 (104) is associated with security object 204, and a user N (138) (shown in FIG. 1) is associated with security object 208. Based on mapping information maintained in mapping component 136, data access component 142 provides user 102 with access to data owned by or shared to user 104, and to data owned by or shared to user 138. Likewise, user 104 is allowed access to data owned by or shared to user 138.

In one example, update access is provided to users who are one level higher in the security hierarchy. That is, in the example illustrated in FIG. 3A, user 102 can update data owned by or shared to user 104 and user 104 can update data owned by or shared to user 138.

In one example, a depth of user data access within hierarchy model 200 is configurable. Briefly, in one example the depth refers to a number of levels down into the hierarchy that the access privileges extend. That is, if the depth is set to one, user 102 can access data associated (e.g., owned by and/or shared to) with user 104 and any users associated with security object 206, but not data associated with users in level 222. If the depth is set to two, user 102 can access data associated with user 138 and any other users associated with security objects in level 222.

In one example, mapping component 136 builds a flat list of the hierarchy by maintaining a mapping table that maps user IDs. FIG. 3B illustrates one example of a hierarchical security mapping table 224 that includes a plurality of entries, in the form of rows 226-1, 226-2, 226-3, 226-N, etc. (collectively referred to as rows 226). A first column 228 stores a parent user ID, that identifies a first user associated with a parent security object in the hierarchy model, and a second column 230 stores a child user ID, that identifies a second user associated with a related child security object that is mapped to the first user. In this manner, each row 226 maps users based on the hierarchy model.

For sake of further illustration, but not by limitation, mapping table 224 will be described in the context of hierarchy model 200. Mapping component 136 builds mapping table 224 based on the hierarchy depth and the user associations to the security objects configured by administrator 144. For example, if the depth is set to one, mapping table 224 includes a first entry 226-1 that maps user 102 to user 104, which indicates that user 102 can access data associated with user 104, and a second entry 226-2 that maps user 104 to user 138, which indicates that user 104 can access data associated with user 138. If the depth is set or changed to two (or greater), a third entry 226-3 is added to mapping table 224 that maps user 102 to user 138, which indicates that user 102 can access data associated with user 138. In other words, mapping table 224 is used to manage a mapping between users in a higher level of hierarchy model 134 and users in a lower level of hierarchy model 134. As security objects in hierarchy model 200 are created, modified, moved, and/or deleted, or if the hierarchy depth is changed, mapping component 136 updates the rows 226 of mapping table 224 accordingly.

FIG. 3C illustrates another example of a mapping table 232 that is similar to mapping table 224, except that only a single entry is created for each parent user ID. That is, mapping table 232 includes a plurality of entries, in the form of rows 234-1, 234-2, 234-3, 234-N, etc. (collectively referred to as rows 234). A first column 236 stores a parent user ID and a plurality of child user ID columns 238, 240, and 242 store child user IDs that identify a number of other users associated with related child security objects that are mapped to the first user. As shown in FIG. 3C, a first entry 234-1 maps user 102 to both users 104 and 138, and a second entry 234-2 maps user 104 to user 138. As security objects in hierarchy model 200 are created, modified, moved, and/or deleted, or if the hierarchy depth is changed, mapping component 136 updates the rows 234 of mapping table 232 accordingly. Mapping tables 224 and 232 are, of course, examples only.

Additionally, in one example, multiple independent hierarchy models can be defined. For instance, it may be desired to provide separate hierarchy models for handling different parts of an organization. For example, it may be desired that user 138, who is associated with security object 208 in model 200, has access to data associated with user 102. As such, a second, separate hierarchy model can be defined in which user 138 is associated with a security object that is a parent to a child security object that is associated with user 102. As such, multiple security objects can be root nodes such that they do not have a parent security object. Multiple hierarchy models can be managed using a same or different mapping tables.

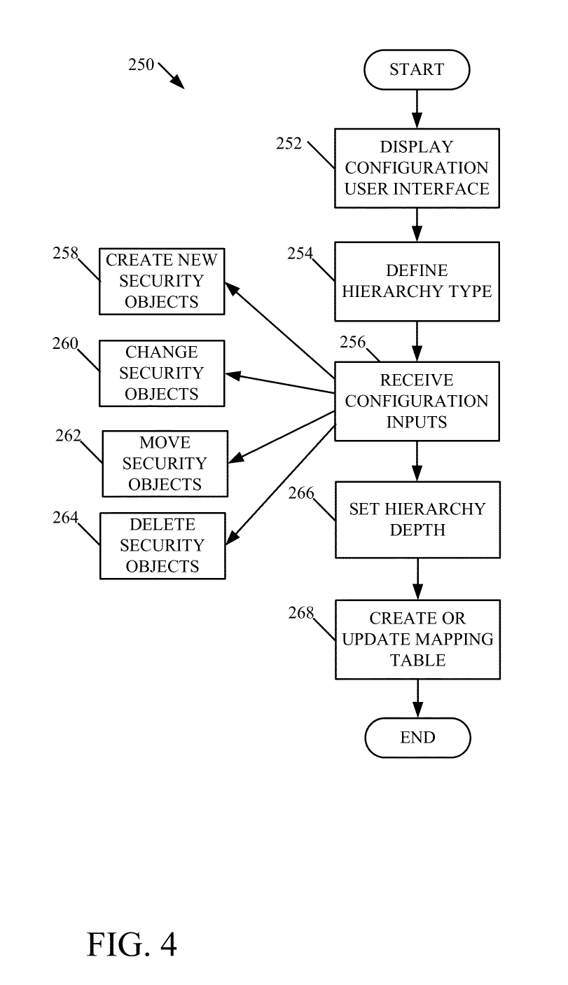

FIG. 4 is a flow diagram illustrating one example of a method 250 for configuring a hierarchical security component. For sake of illustration, but not by limitation, method 250 will be described in the context of a user, such as administrator 144, using configuration component 140 to configure hierarchical security component 132.

At block 252, a configuration user interface is displayed to administrator 144. The configuration user interface includes user input mechanisms that are used to sense user interaction with computing system 101. In one example of block 252, through the user input mechanisms administrator 144 can choose to create a new hierarchy model or to modify an existing hierarchy model.

At block 254, a user input is received through the user input mechanisms that defines or changes a hierarchy type for the hierarchy model. For example, the administrator 144 can select from a plurality of type options, including but not limited to a user hierarchy and a position hierarchy.

At block 256, administrator 144 provides configuration inputs through the user input mechanisms to define a desired user hierarchy for controlling data access among users. The configuration inputs are received, through the configuration user interface, to configure the hierarchy model. For example, the configuration inputs can create a new security object at block 258, change an existing security object at block 260, move a security object at block 262, and/or delete a security object at block 264.

In one example of block 258, administrator 144 create a root object or node (e.g., object 202 in hierarchy model 200) by identifying a first user or group of users. Then, administrator 144 creates a child object or node (e.g., object 204 in hierarchy model 200) by identifying a second user or group of users for which the first user is to have data access. This is performed, in one example, by user inputs that specifically identify the first user and a relationship between the first and second users, such as the first user being a manager of the second user.

In one example of block 260, administrator 144 can change a user that is associated with a security object and/or add users to the security object.

In one example of block 262, administrator 144 can move a security object to depend from a different parent object. For example, in the context of hierarchy model 200, user 138 may have moved within an organizational structure in a manner that changes reporting lines. That is, user 138 may have moved from being managed by user 104 to being managed by a different user associated with security object 206. In this example, administrator 144 can move security object 208 to dependent from security object 206.

In one example of block 264, a security object can be deleted if a user is removed from the hierarchy such that there are no users associated with the security object and the security object has no child objects.

At block 266, administrator 144 can set the hierarchy depth to be used in granting access privileges to the users.

At block 268, mapping component 136 creates or updates a mapping table based on the configuration inputs received at block 256 and the hierarchy depth set at block 266.

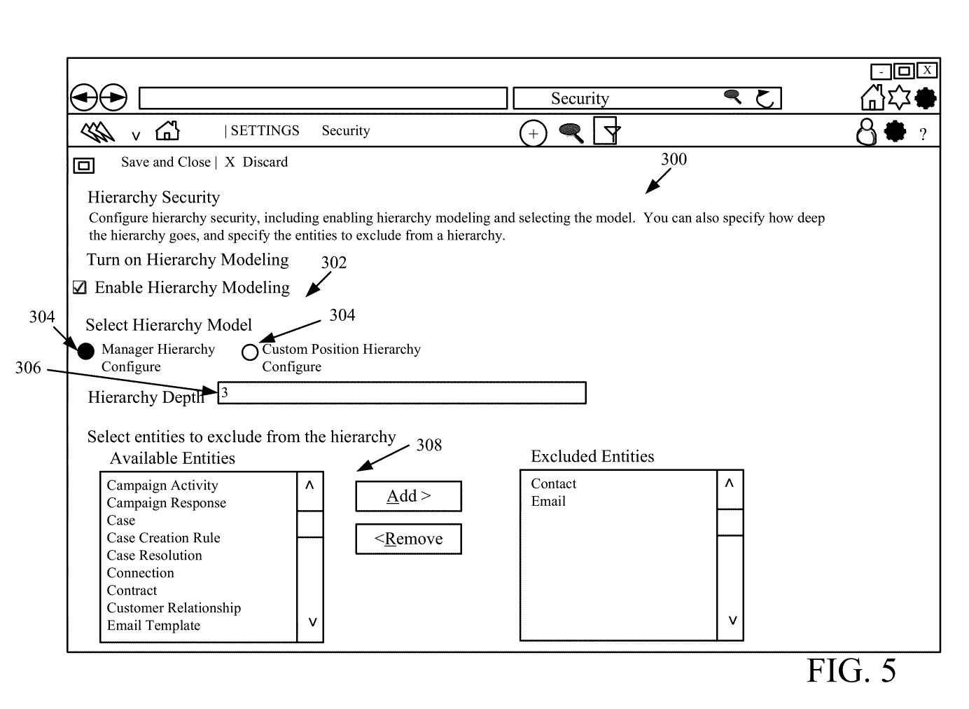

FIGS. 5-7 illustrate examples of user interface displays for configuring a hierarchical security component. For sake of illustration, by not by limitation, FIGS. 5-7 will be described in the context of administrator 144 using method 250 to configure hierarchical security component 132.

FIG. 5 illustrates a configuration display 300 that is displayed to administrator 144 at block 252. Display 300 includes an enable control element 302 for enabling hierarchical security component 132. In one example, disabling control element 302 causes hierarchical security component 136 to remove all entries from mapping component 136.

Display 300 also includes type control elements 304 for selecting one of a plurality of different hierarchy model types. In the illustrated example, administrator 144 can select a user hierarchy (e.g., a manager hierarchy) or a position hierarchy. These, of course, are examples only.

Display 300 also includes a depth control element 306 that allows administrator 144 to set the hierarchy depth and an entity control 308 that allows administrator 144 to select entities to be excluded from the hierarchy. In the illustrated example, the entities “Contact” and “Email” are selected as entities to be excluded from the hierarchical security. When an entity or entity type is excluded, the user data access granted by security component 132 will not include those entities or entity types.

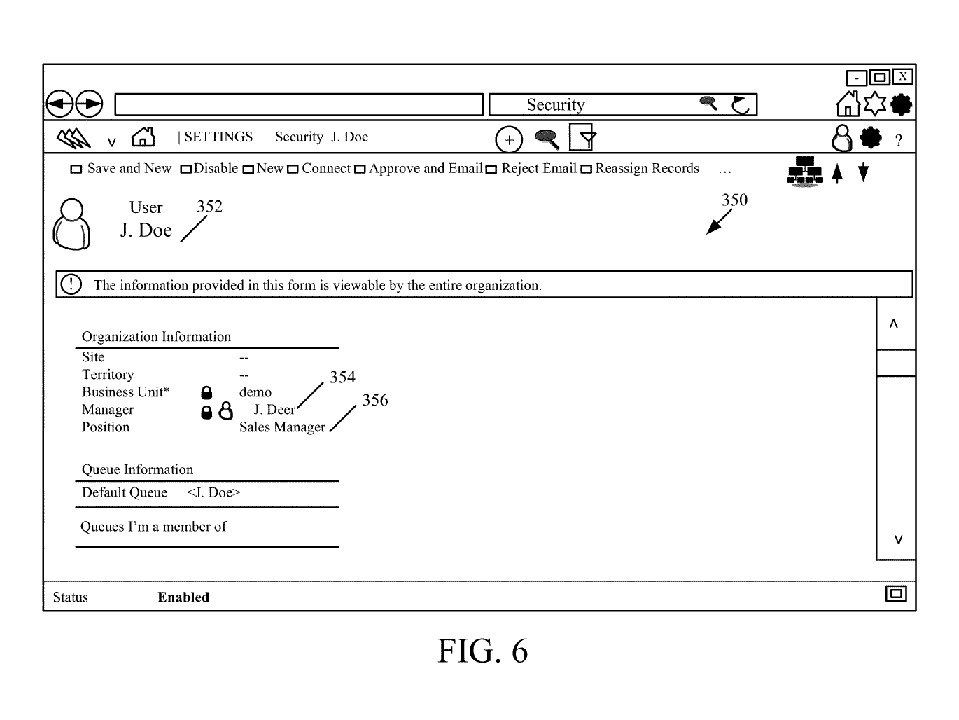

FIG. 6 illustrates a manager hierarchy configuration display 350. In one example, display 350 is rendered in response to administrator 144 selecting to configure a manager hierarchy at control element 304 in FIG. 5. Display 350 includes a user input mechanism 352 that receives an input identifying a particular user and a user input mechanism 354 that receives an input identifying a parent security object (in this case, the user's manager). Display 350 allows administrator 144 to map associations between users for providing data access privileges. Display 350 can also include a user input mechanism 356 that receives an input identifying a position associated with the user.

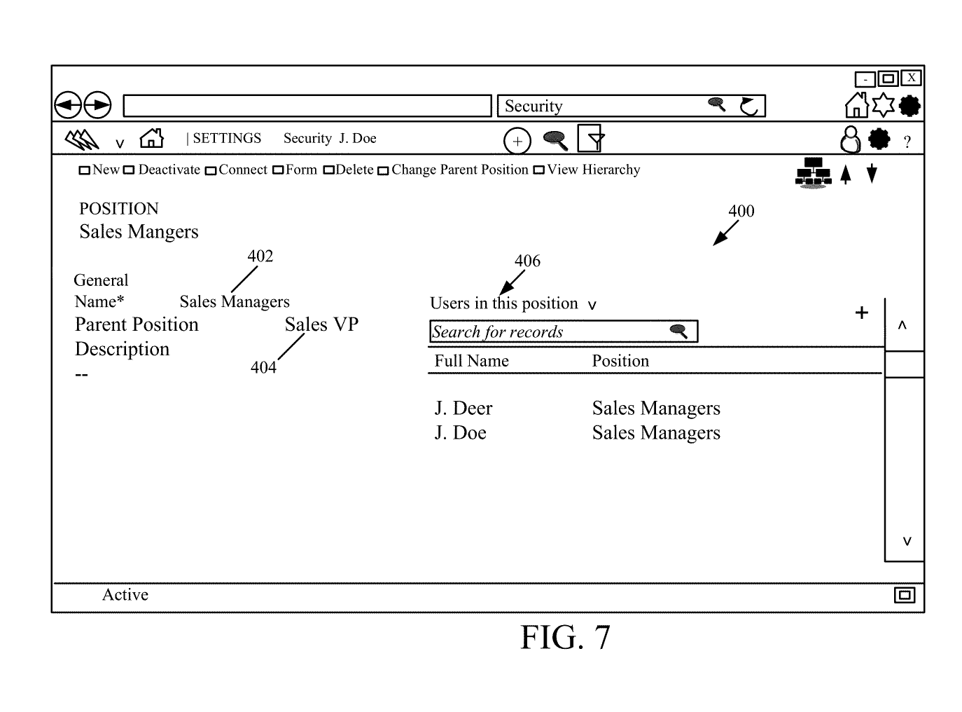

FIG. 7 illustrates a position hierarchy configuration display 400. In one example, display 400 is rendered in response to administrator 144 selecting to configure a position hierarchy at control element 304 in FIG. 5. Display 400 includes a user input mechanism 402 for defining a name for the position and a user input mechanism 404 for defining a parent position. In the illustrated example, the position “Sales Managers” is a child position and depends from the parent position “Sales VP.” In the context of model 200 illustrated in FIG. 3A, for example, the “Sales Managers” position can be associated with security object 206 and the parent position “Sales VP” can be associated with security object 202. Display 400 also includes user input mechanisms 406 that allow administrator 144 to view, add, and delete users from the “Sales Managers” position.

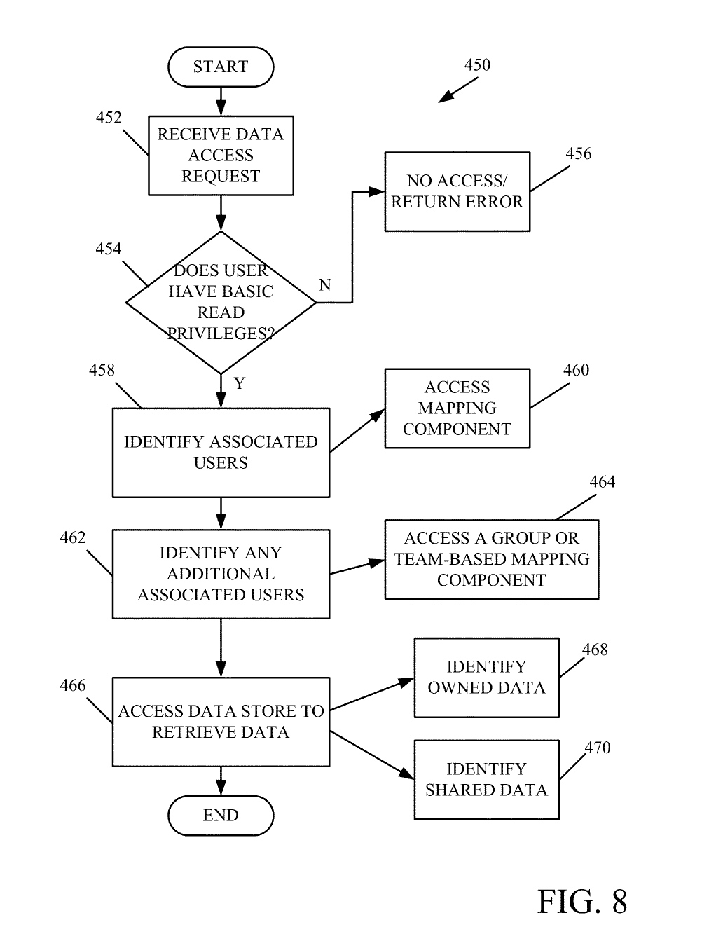

FIG. 8 is a flow diagram illustrating one example of a method 450 for providing or preventing user data access to requested system data using a hierarchical security component. For sake of illustration, but not for limitation, method 450 will be described in the context of using data access component 142 to access data store 110 based on hierarchical security component 132.

At block 452, a data access request is received at data access component 142 from a requesting user. For example, the data access request can be received from user 102 who desires access to a set of data objects in data store 110. Based on an identity of user 102 (e.g., user 102 can perform a login or authentication procedure), block 454 determines whether user 102 has basic read privileges within computing system 101. For example, data access component 142 can determine whether user 102 has read privileges for an entity type being requested. If user 102 does not have read privileges, user 102 is not given access and an error message can return at block 456. Block 456 prevents access to the requested data objects in data store 110 and notifies the user that access is not granted, for example, by displaying an error or warning message on the computer monitor, issuing an appropriate sound or other output.

At block 458, data access component 142 identifies users that are associated with the requesting user based on a security hierarchy model. For example, data access component 142 accessing mapping component 136 at block 460 to identify a set of users that are at a lower level in the security hierarchy than the requesting user.

At block 462, data access component 142 identifies any additional users that are associated with the set of users identified at block 458. For example, data access component 142 accesses a group or team-based mapping component (e.g., user group associations 129) at block 464 to determine if any users in the set of users are associated with other users in a group or team.

At block 466, data access component 142 accesses data store 110 to retrieve data objects based on the users identified at blocks 458 and 462. In one example, block 466 identifies owned data at block 468, and identifies shared data at block 470, where the owned data comprises data that is owned by the users identified at blocks 458 and 462 and the shared data comprises data that is shared to the users identified at block 458 and 462. The owned data can be identified based on owner attributes attached to the data objects and the shared data can be identified using a sharing table, such as table 127.

In one example of block 466, a query statement (e.g., a SQL statement) is generated to return records from data store 110 that are owned by or shared to the identified users. For instance, a filtering SQL statement can be built at block 466 by creating a union (for example, using a join function) of a plurality of separate queries that are generated to identify owned data for the associated users, shared data for the associated users, and/or shared data for users that are a member of a common group or team as the associated users.

It can thus be seen that the present description provides a variety of technical advantages. For example, but not by limitation, data security component 130 provides a flexible security architecture that can be easily adapted as the realities of an organization changes (e.g., new users are added, existing users move positions or change managers, existing users are removed from the organization). Data security component 130 can therefore enhance granularity in granting data access permissions and improve the accuracy of the data security relative to the organizational realities. Further, data security component 130 provides for efficient and accurate calculation of the data access privileges, even when an organization has a large number of users, which can decrease processing bandwidth and data access latency.

To further illustrate the foregoing, in some implementations other models such as business unit or role hierarchies may not be sufficient for controlling broader access as the realities of the organizational structure and access needs do not always align. A given user within an organization may have a “Sales Manager” role that grants the user access rights to view all accounts in a particular unit within the organization. Further, it may be desired to grant that user access rights to records owned by other users in a separate unit within the organization. With a role hierarchy, providing user 102 with access to those records requires assigning the “Sales Manager” role access privileges to the records owned by the other users. However, this assignment may grant unwanted privileges to other users in the “Sales Manager” role.

Conversely, in the above scenario, data security component 130 can be used by administrator 144 to assign the user a position within hierarchical security component 132 that parents the other users such that the user is granted read access to the records owned by the other users without needing to granting unwanted privileges to the other users in the “Sales Manager” role.

The present discussion mentions processors and servers. In one example, the processors and servers include computer processors with associated memory and timing circuitry, not separately shown. They are functional parts of the systems or devices to which they belong and are activated by, and facilitate the functionality of the other modules, components and/or items in those systems.

Also, a number of user interface displays have been discussed. They can take a wide variety of different forms and can have a wide variety of different user actuatable input mechanisms disposed thereon. The user actuatable input mechanisms sense user interaction with the computing system. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores are also discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

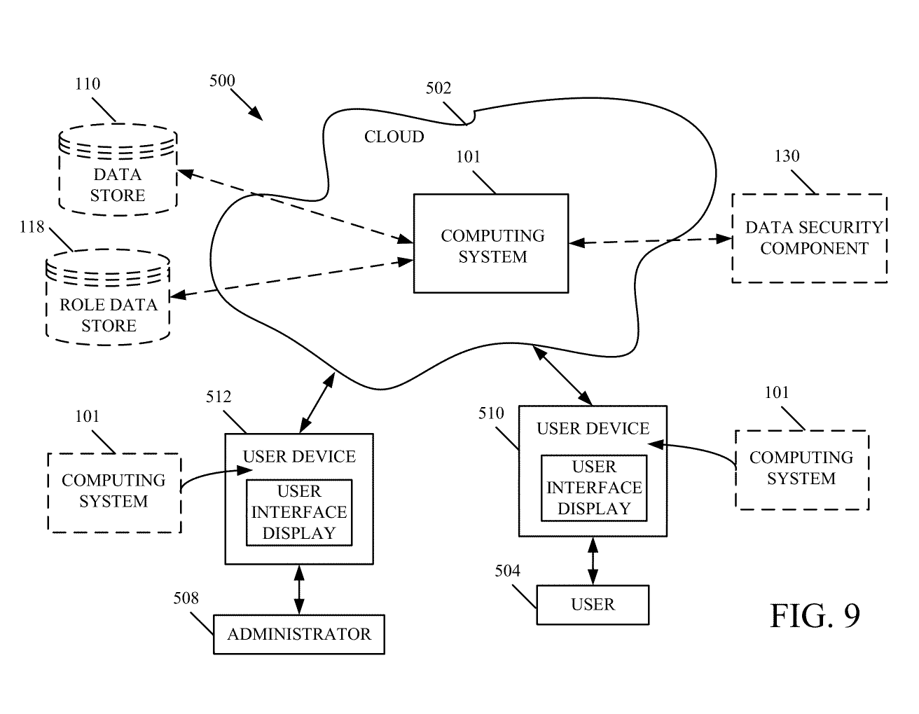

FIG. 9 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software, modules, or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the modules, components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 9, some items correspond to those shown in FIG. 1 and they are similarly numbered. FIG. 9 specifically shows that computing system 101 is located in cloud 502 (which can be public, private, or a combination where portions are public while others are private). Therefore, a user 504 (e.g., user 102, 104, or 138) and an administrator 506 (e.g., administrator 144) use user devices 510 and 512, respectively, to access system 101 through cloud 502.

FIG. 9 also depicts another embodiment of a cloud architecture. FIG. 9 shows that it is also contemplated that some components of computing system 101 are disposed in cloud 502 while others are not. By way of example, data stores 110 and 118 can be disposed outside of cloud 502, and accessed through cloud 502. In another embodiment, data security component 130 is also outside of cloud 502. Regardless of where they are located, system 101 components can be accessed directly by devices 510 and 512, through a network (either a wide area network or a local area network), they can be hosted at a remote site by a service, or they can be provided as a service through a cloud or accessed by a connection service that resides in the cloud. FIG. 5 also shows that system 101, or parts of it, can be deployed on user devices 510 and/or 512. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

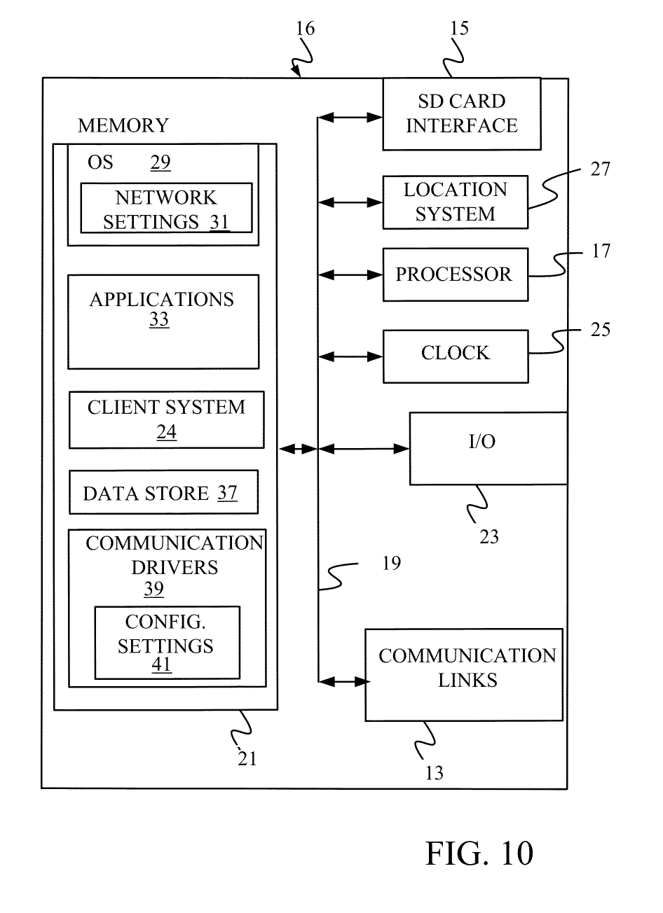

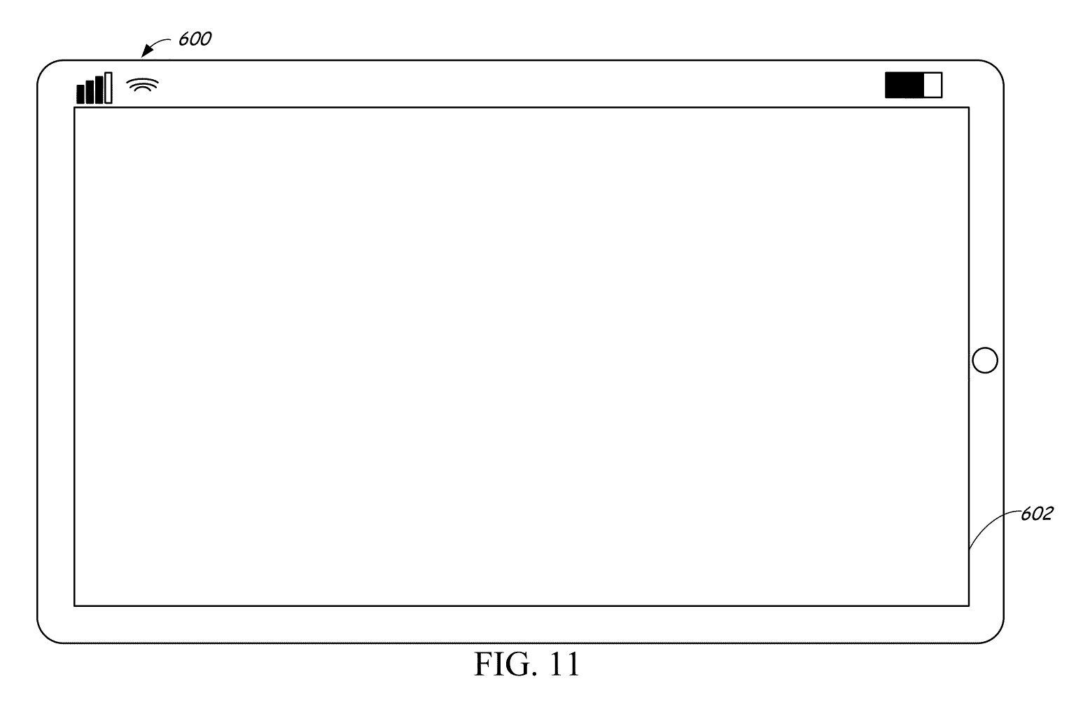

FIG. 10 is a simplified block diagram of one example of a handheld or mobile computing device that can be used as a user's or client's hand held device 16, in which the present system (or parts of it) can be deployed. FIGS. 11-14 are examples of handheld or mobile devices.

FIG. 10 provides a general block diagram of the components of a client device 16 that can run modules or components of architecture 100 or that interacts with architecture 100, or both. In the device 16, a communications link 13 is provided that allows the handheld device to communicate with other computing devices and in some examples provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

In other examples, applications or systems are received on a removable Secure Digital (SD) card that is connected to a SD card interface 15. SD card interface 15 and communications link 13 communicate with a processor 17 (which can also embody processor(s) 114 from FIG. 1) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 comprises a real time clock component that outputs a time and date. It can also provide timing functions for processor 17.

Location system 27 includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. It can also store a client system 24 which can be part or all of architecture 100. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other modules or components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 11 shows one example in which device 16 is a tablet computer 600. In FIG. 11, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also receive voice inputs as well.

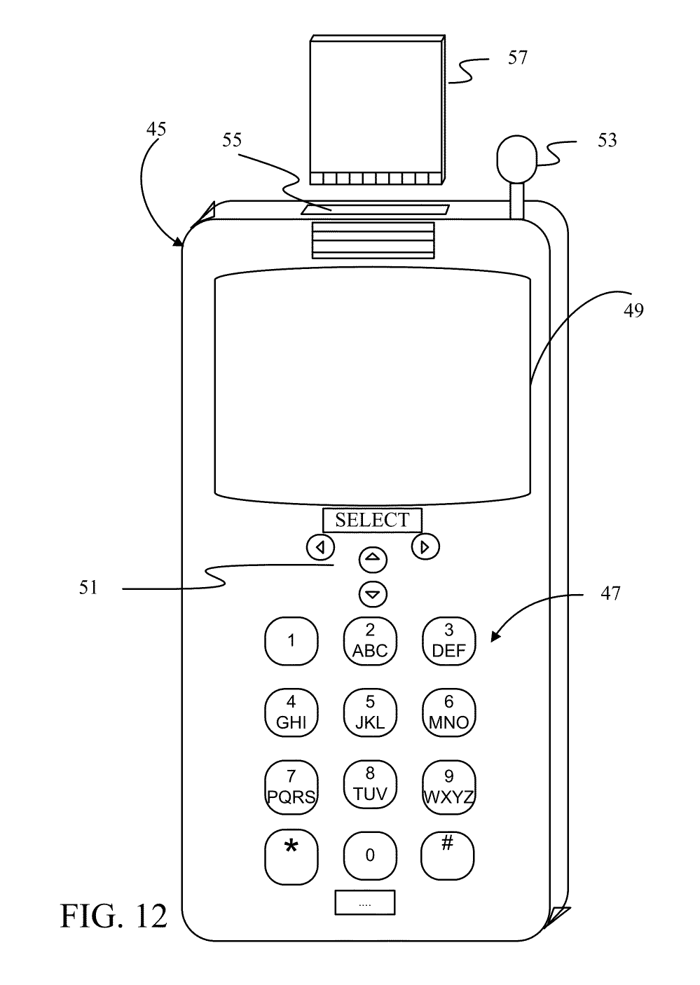

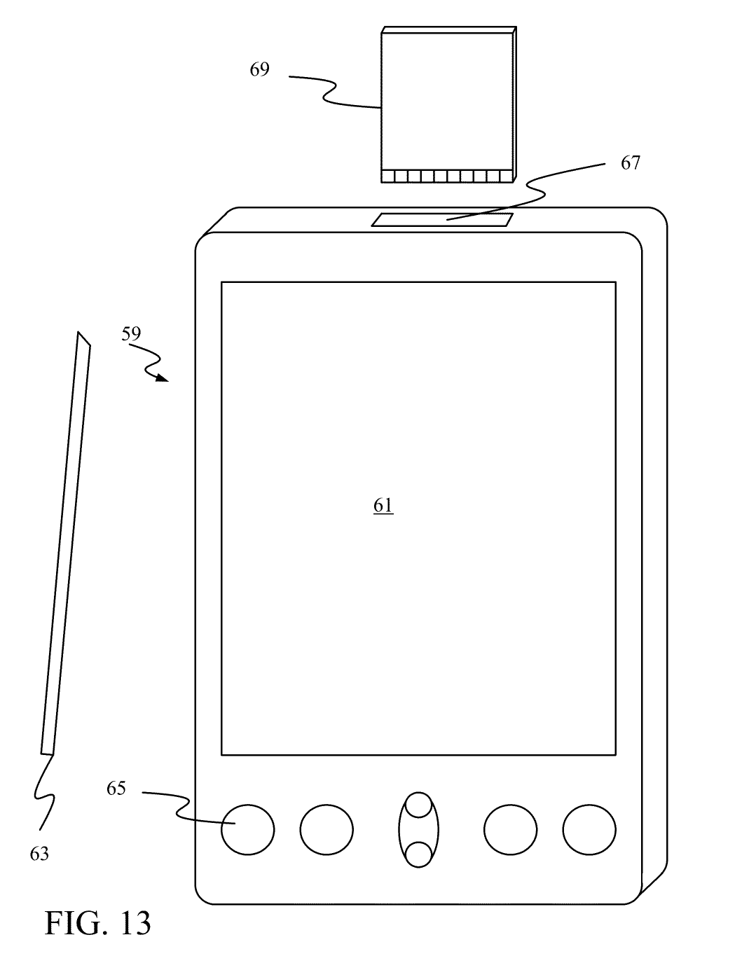

FIGS. 12 and 13 provide additional examples of devices 16 that can be used, although others can be used as well. In FIG. 12, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some examples, phone 45 also includes a Secure Digital (SD) card slot 55 that accepts a SD card 57.

The mobile device of FIG. 13 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one example, mobile device 59 also includes a SD card slot 67 that accepts a SD card 69.

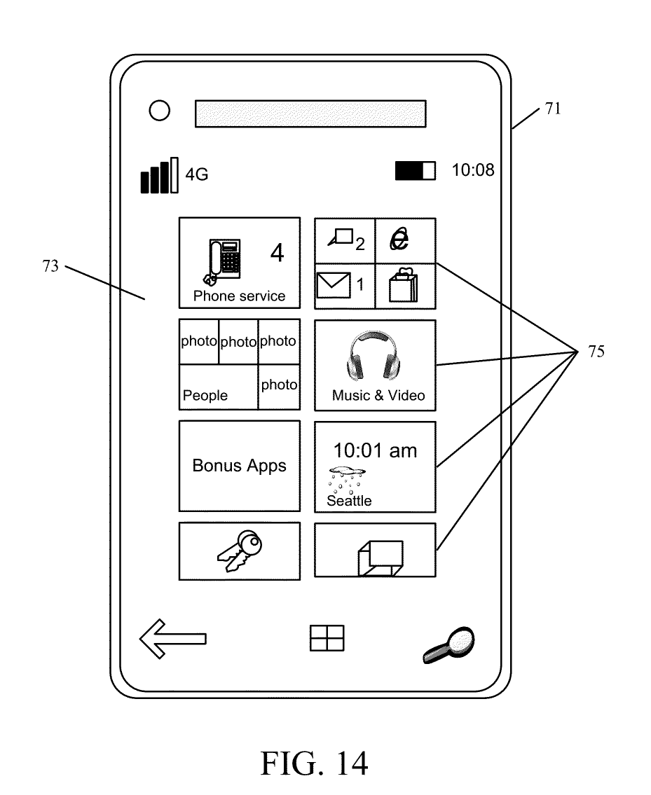

FIG. 14 is similar to FIG. 12 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

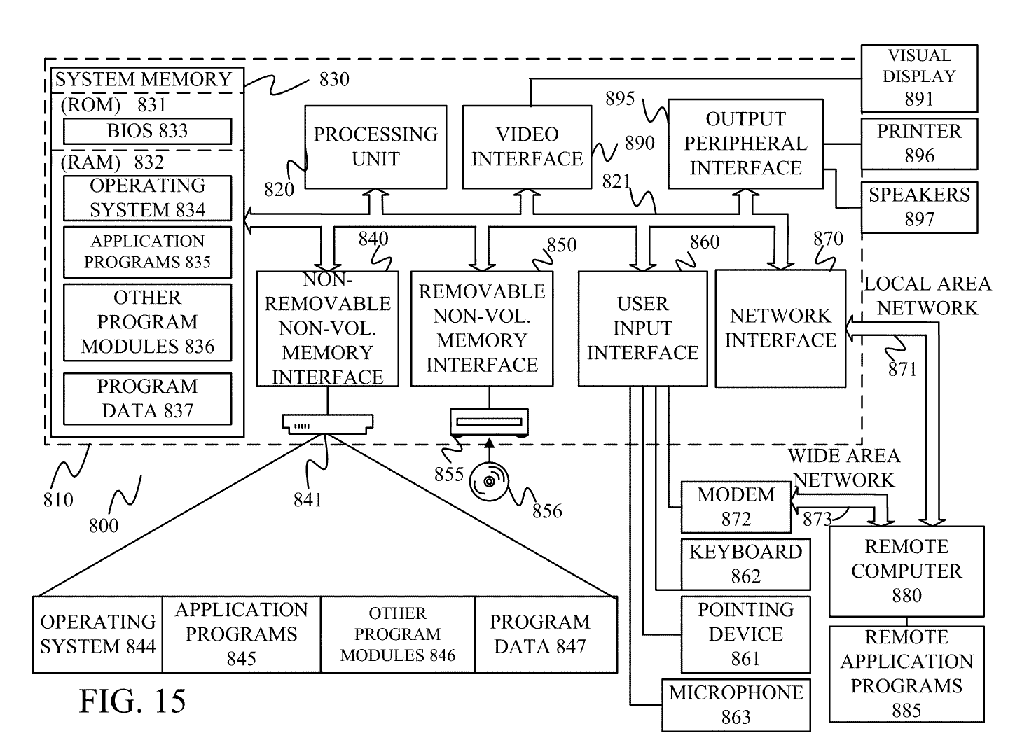

FIG. 15 is one example of a computing environment in which architecture 100, or parts of it, (for example) can be deployed. With reference to FIG. 15, an exemplary system for implementing some examples includes a general-purpose computing device in the form of a computer 810. Components of computer 810 may include, but are not limited to, a processing unit 820 (which can comprise processor(s) 114), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 15.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 773, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 15 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system comprising a user interface component configured to generate a data security configuration interface that displays user input mechanisms and receives user configuration inputs, and a data security component configured to control user data access. The data security component comprises a plurality of configurable security objects arranged in a security hierarchy. The configuration inputs associate at least one user with each security object in the security hierarchy to define a data access relationship between the users associated with the security objects. The data security component also comprises a data access component configured to receive a data access request from a given user, identify a set of users that are associated with security objects in the security hierarchy relative to a security object to which the given user is associated, and provide the given user with access to data objects that are associated with the set of users.

Example 2 is the computing system of any or all previous examples, wherein the security hierarchy comprises a plurality of levels, each level having at least one security object, and wherein the data access component is configured to identify the set of users such that each user in the set is associated with a security object that is at a lower level in the security hierarchy relative to the security object to which the given user is associated.

Example 3 is the computing system of any or all previous examples, wherein the plurality of levels comprises a first level having a first level security object and a second level having a plurality of second level security objects that are each child objects of the first level security object, the given user being associated with the first level security object and each user in the set of users is associated with the second level security objects.

Example 4 is the computing system of any or all previous examples, wherein the data access component is configured to provide the given user with update access for the data objects associated with the set of users.

Example 5 is the computing system of any or all previous examples, wherein the configuration inputs define a depth within the security hierarchy for which user data access is provided by the data access component.

Example 6 is the computing system of any or all previous examples, wherein the depth comprises a number of levels in the security hierarchy.

Example 7 is the computing system of any or all previous examples, wherein the configuration inputs associate a group of users with one of the security objects in the security hierarchy, and the data access component is configured to provide the given user with access to data objects in the data store that are associated with each user in the group of users.

Example 8 is the computing system of any or all previous examples, and further comprising a data store that stores the data objects, each data object in the data store being associated with a particular user.

Example 9 is the computing system of any or all previous examples, wherein each data object includes an owner attribute that identifies the particular user as an owner of the data object.

Example 10 is the computing system of any or all previous examples, wherein the data access component is configured to provide the given user with access to the data objects by identifying data objects that are owned by and shared with each user in the set of users.

Example 11 is the computing system of any or all previous examples, wherein the data store comprises a relational database and each data object comprises a row in the relational database, and wherein the data access component is configured to provide the given user with read access to the rows of the relational data that are associated with the set of users.

Example 12 is the computing system of any or all previous examples, wherein the data security component comprises a second plurality of configurable security objects arranged in a second security hierarchy. The configuration inputs associate at least one user with each security object in the second security hierarchy to define a data access relationship between the users associated with the second plurality of configurable security objects. The data access component is configured to identify a second set of users that are associated with security objects in the second security hierarchy relative to a security object to which the given user is associated and provide the given user with access to data objects that are associated with the second set of users.

Example 13 is the computing system of any or all previous examples, wherein the given user is assigned a role having role-based access privileges, and the data access component is configured to provide the given user with access to the data are associated with the set of users independent of the role-based access privileges.

Example 14 is the computing system of any or all previous examples, and further comprising a role-based security hierarchy configured to provide user data access based on a role hierarchy and the role-based access privileges of roles with the role hierarchy.

Example 15 is a computing system comprising a security model component that associates a plurality of users in a security hierarchy having a plurality of hierarchical levels, a user interface component configured to generate a user configuration interface that displays user input mechanisms and receives a configuration input indicative of a depth within the security hierarchy, and a data access component configured to receive a data access request from a given user and to provide the given user with access to data associated with one or more of the users based on the depth.

Example 16 is the computing system of any or all previous examples, wherein the depth identifies a number of hierarchical levels within the security hierarchy.

Example 17 is the computing system of any or all previous examples, wherein the given user is associated with a first level in the security hierarchy, and wherein the data access component is configured to identify a set of users that are associated with levels in the security hierarchy that are within the depth from the first level.

Example 18 is a computer-implemented method comprising receiving a data access request from a first user, accessing, using a computer processor, a hierarchical security model to identify a set of users that are related to the first user by the hierarchical security model, identifying owned data that is owned by the set of users, identifying shared data that is shared with the set of users, and facilitating access by the first user to the set of owned data and the set of shared data.

Example 19 is the computer-implemented method of any or all previous examples, wherein identifying the set of users comprises identifying a first node in the hierarchical security model that is associated with the first user, identifying a plurality of other nodes in the hierarchical security model that are at a lower level in the hierarchical security model than the first node, and identifying users that are associated with the plurality of other nodes.

Example 20 is the computer-implemented method of any or all previous examples, wherein the owned data comprises data that is owned by a group of users and the shared data comprises data that is shared with the group of users.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A computing system comprising:
a user interface component configured to generate a data security configuration interface that displays user input mechanisms and receives user configuration inputs; and
a data security component configured to control user data access, the data security component comprising:
a plurality of configurable security objects arranged in a security hierarchy, wherein the configuration inputs associate at least one user with each security object in the security hierarchy to define a data access relationship between the users associated with the security objects; and
a data access component configured to receive a data access request from a given user, identify a set of users that are associated with security objects in the security hierarchy relative to a security object to which the given user is associated, and provide the given user with access to data objects that are associated with the set of users.

2. The computing system of claim 1, wherein the security hierarchy comprises a plurality of levels, each level having at least one security object, and wherein the data access component is configured to identify the set of users such that each user in the set is associated with a security object that is at a lower level in the security hierarchy relative to the security object to which the given user is associated.

3. The computing system of claim 2, wherein the plurality of levels comprises a first level having a first level security object and a second level having a plurality of second level security objects that are each child objects of the first level security object, the given user being associated with the first level security object and each user in the set of users is associated with the second level security objects.

4. The computing system of claim 3, wherein the data access component is configured to provide the given user with update access for the data objects associated with the set of users.

5. The computing system of claim 2, wherein the configuration inputs define a depth within the security hierarchy for which user data access is provided by the data access component.

6. The computing system of claim 5, wherein the depth comprises a number of levels in the security hierarchy.

7. The computing system of claim 1, wherein the configuration inputs associate a group of users with one of the security objects in the security hierarchy, and the data access component is configured to provide the given user with access to data objects in the data store that are associated with each user in the group of users.

8. The computing system of claim 1, and further comprising:
a data store that stores the data objects, each data object in the data store being associated with a particular user.

9. The computing system of claim 8, wherein each data object includes an owner attribute that identifies the particular user as an owner of the data object.

10. The computing system of claim 9, wherein the data access component is configured to provide the given user with access to the data objects by identifying data objects that are owned by and shared with each user in the set of users.

11. The computer system of claim 1, wherein the data store comprises a relational database and each data object comprises a row in the relational database, and wherein the data access component is configured to provide the given user with read access to the rows of the relational data that are associated with the set of users.

12. The computer system of claim 1, wherein the data security component comprises:
a second plurality of configurable security objects arranged in a second security hierarchy, wherein the configuration inputs associate at least one user with each security object in the second security hierarchy to define a data access relationship between the users associated with the second plurality of configurable security objects, wherein the data access component is configured to identify a second set of users that are associated with security objects in the second security hierarchy relative to a security object to which the given user is associated and provide the given user with access to data objects that are associated with the second set of users.

13. The computer system of claim 1, wherein the given user is assigned a role having role-based access privileges, and the data access component is configured to provide the given user with access to the data are associated with the set of users independent of the role-based access privileges.

14. The computer system of claim 13, and further comprising a role-based security hierarchy configured to provide user data access based on a role hierarchy and the role-based access privileges of roles with the role hierarchy.

15. A computing system comprising:
a security model component that associates a plurality of users in a security hierarchy having a plurality of hierarchical levels;
a user interface component configured to generate a user configuration interface that displays user input mechanisms and receives a configuration input indicative of a depth within the security hierarchy; and
a data access component configured to receive a data access request from a given user and to provide the given user with access to data associated with one or more of the users based on the depth.

16. The computer system of claim 15, wherein the depth identifies a number of hierarchical levels within the security hierarchy.

17. The computer system of claim 15, wherein the given user is associated with a first level in the security hierarchy, and wherein the data access component is configured to identify a set of users that are associated with levels in the security hierarchy that are within the depth from the first level.

18. A computer-implemented method comprising:
receiving a data access request from a first user;
accessing, using a computer processor, a hierarchical security model to identify a set of users that are related to the first user by the hierarchical security model;
identifying owned data that is owned by the set of users;
identifying shared data that is shared with the set of users; and
facilitating access by the first user to the set of owned data and the set of shared data.

19. The computer-implemented method of claim 18, wherein identifying the set of users comprises:
identifying a first node in the hierarchical security model that is associated with the first user;
identifying a plurality of other nodes in the hierarchical security model that are at a lower level in the hierarchical security model than the first node; and
identifying users that are associated with the plurality of other nodes.

20. The computer-implemented method of claim 18, wherein the owned data comprises data that is owned by a group of users and the shared data comprises data that is shared with the group of users.
